(19) United States
(12) Patent Application Publication
(10) Pub. No.: US 2020/0401966 A1
(43) Pub. Date: Dec. 24, 2020

(54) RESPONSE GENERATION FOR PREDICTED EVENT-DRIVEN INTERACTIONS

(71) Applicant: Wells Fargo Bank, N.A., San Francisco, CA (US)

(72) Inventors: Zachary Scott Miinch, University City, MO (US); John C. Brenner, Chesterfield, MO (US); Jeniffer Justice, San Francisco, MN (US); Gwendoria M. Salley, Rock Hill, SC (US); Chad Allen Yarbrough, St. Louis, MO (US); James D. Cahill, Belmont, MA (US)

(21) Appl. No.: 15/391,686

(22) Filed: Dec. 27, 2016

(51) Int. Cl. G06Q 10/06

(52) U.S. Cl. CPC G06Q 10/06315; G06Q 10/067

(57) ABSTRACT

Systems and techniques for response generation for predicted even-driven interactions are described herein. A set of event data and a set of interaction data may be obtained. The set of event data and the set of interaction data may be evaluated to determine a correlation between an event that corresponds to the set of event data and an interaction that corresponds to the set of interaction data. A set of profile data may be collected that is associated with the interaction. The set of profile data may be compared to a user profile to determine a predicted interaction. Options to respond to the predicted interaction may be transmitted to an administrator based on the comparison.

### TECHNICAL FIELD

The present subject matter relates to the field of predictive analytics. Specifically, in some example embodiments, in generating response options to event-driven predicted interactions using user profile data.

### BACKGROUND

Events (e.g., a new product launch, a news release concerning an organization, etc.) happen that cause customers to make contact with a business. Increased interaction from events increases the load on electronic systems of the business and the load on the business' employees. Businesses may adjust to increased volume after the increase in interactions occur to reduce the impact such as expanding electronic system capacity and bringing in additional staff.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment and a system for response generation for predicted event-driven interactions, according to some embodiments.

FIG. 2 illustrates a block diagram of an example of an interaction prediction and response engine for response generation for predicted event-driven interactions, according to some embodiments.

FIG. 3 illustrates flow diagram of an example of a method for response generation for predicted event-driven interactions, according to some embodiments.

FIG. 4 illustrates an example machine learning component for response generation for predicted event-driven interactions, according to some embodiments.

FIG. 5 is a block diagram illustrating an example of a machine upon which one or more embodiments may be implemented.

### DETAILED DESCRIPTION

Certain events may cause an individual to make contact with an organization with which the individual has a relationship. For example, a customer of an electronics company may inquire about availability of a new product when the electronics company displays the new product at a trade show. In another example, a client of a financial institution may inquire about the client's equity holdings with the financial institution when trending posts on a social media site to which the client belongs contain negative (or positive) coverage of a company in which the client is (or wishes to be) an investor.

With the increasing prevalence of online information gathering, information regarding events may be propagated more rapidly which may, in turn, result in spikes in interactions. Spikes in interactions may place an increased load on the electronic systems of a business that is the recipient of the increased interactions. For example, the telephone systems, webservers, and other technology resources may become overloaded by a severe interaction increase leading to system failures that may leave customers dissatisfied potentially resulting in a loss of customers.

The problem of spikes in interactions causing strain on a business' technology infrastructure may be addressed through early detection of events in which customers are most likely to initiate interaction based on the event. The event may be detected by monitoring a variety of data sources (e.g., social network posts, news websites, blogs, etc.) to determine an increase in online discussion of an event (e.g., new products, litigation, corporate activity, etc.) that is gamering increased attention. An increase in interactions resulting from the event may be predicted by monitoring interactions by individuals (e.g., customers, clients, etc.) in which the event has been discussed. The profiles of the individuals initiating contact may be analyzed to establish a model for individuals that are initiating contact. For example, in the case of a client initiating contact with a financial institution, a client's holdings, workplace, social standing, etc. may be aggregated with other individuals initiating interaction may be analyzed to establish the model.

User profiles of an organization may be evaluated against the established model to predict users that are likely to initiate interaction with the organization based on the event. Options for preemptively responding to the event may be generated using the event data and an individual's profile data. For example, an account manager at the financial institution may be presented with a dashboard listing clients that are predicted to initiate interaction along with one or more options for responding to the event. For example, the options may include investment advice based on the event data, an analysis of the event data, or other guidance and/or information deemed to provide the client with the information that would have been sought through an initiated interaction. The options may be generated such that the guidance and/or information is delivered through a communication channel (e.g., telephone, email, social media, etc.) that the individual is most likely to obtain the information from in the timeliest manner. Thus, the individual may not initiate contact thereby reducing the load on the organization's electronic infrastructure.

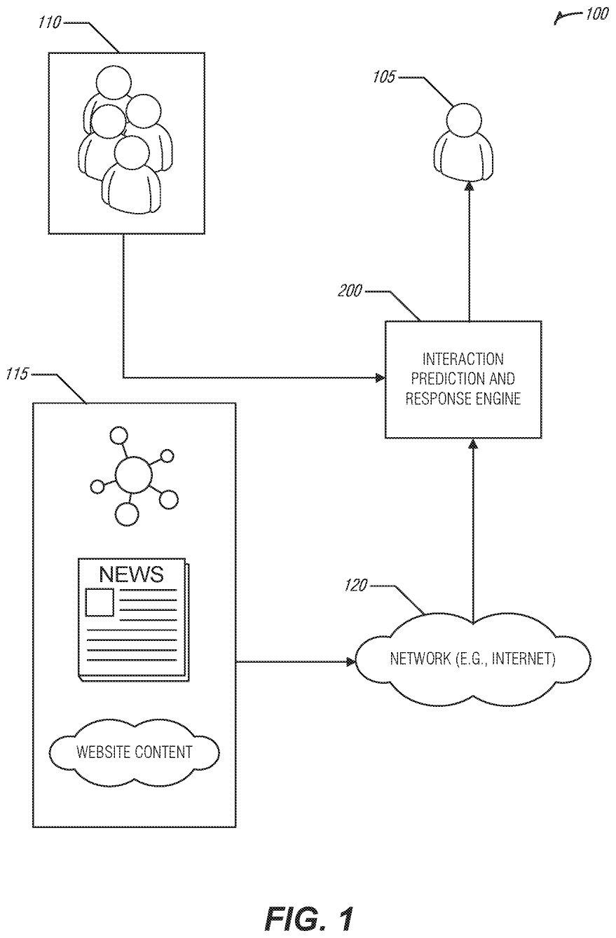

FIG. 1 illustrates an example of an environment 100 and a system 200 for response generation for predicted event-driven interactions, according to some embodiments. The environment 100 may include an individual 105 and an interaction prediction and response engine 200. The interaction prediction and response engine 200 may access a set of interaction data corresponding to a set of user profiles 110 and may be communicatively coupled via a network 120 (e.g., the internet, etc.) to a set of event data sources 115 (e.g., social media websites, news services, website content, etc.).

The set of user profiles 110 may be associated with one or more users that have initiated interaction with an organization using the interaction prediction and response engine 200. The interaction data from the users may be collected by the interaction prediction and response engine 200 to detect an increasing volume of interactions. For example, an event may have occurred that is resulting in an increase in telephone calls to representatives of the organization.

The set of event data sources 115 may be monitored by the interaction prediction and response engine. The data gathered from the set of event data sources 115 may be analyzed to detect an increase in data regarding a common event. For example, keyword searching and/or other techniques may be used to determine common topics among data elements of the set of event data sources 115 to determine that there is an increase in discussion of a new product launched by an electronics manufacturer. In some examples, the analysis may use generative statistical models such as latent dirichlet allocation (LDA) or other topic models to determine the topics.

The interaction data may be aggregated to determine a common topic included in the interaction data. For example, it may be determined that several interactions included a discussion of the new product launched by the electronics manufacturer. In some examples, the interaction data may be evaluated against one or more detected events to determine prevalence of each of the one or more events. For example, the new product launched may be determined to be the most commonly discussed event based on 75% of the interactions including a discussion of the new product and an announcement of a bankruptcy of a shoe company may be determined to be the second most commonly discussed event based on 33% of the interactions including a discussion of the bankruptcy.

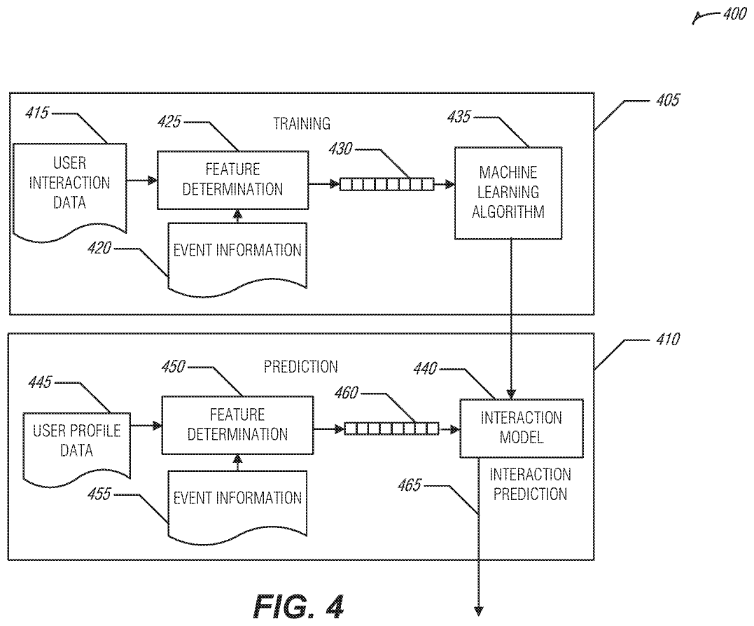

The set of user profiles 110 may be analyzed to establish a model for a user profile likely to initiate interaction with the organization. The model may be developed using machine learning (e.g., using the machine learning component 400 as described in FIG. 4). For example, the set of user profiles and associated profile data of the users initiating interaction based on the event may be labeled to determine features to be included in the model. A user profile may be evaluated against the features of the model to establish whether a user having the user profile is likely to initiate interaction. The analysis may include determining a common set of attributes of a user likely to initiate contact. For example, the model may indicate that a user profile including an investment holding in the electronics retailer and three or more previously initiated interactions in the past year indicates that the user associated with the user profile is likely to initiate contact based on the new product launch. The model may include a variety of attributes and corresponding statistical values indicating the probability that a user with those attributes is likely (or unlikely) to initiate interaction.

In some examples, an event impact score may be determined by evaluating the user's profile attributes. The impact score may be determined based on the potential impact to the user with regard to the organization. For example, a user holding 100 shares of the electronic company stock may have a an impact score of 1 based on the 100 shares of the electronic company stock representing 0.01% of the user's total account holdings with the organization and a user holding 10,000 shares of the electronic company stock may have an impact score of 10 based on the 10,000 shares representing 100% of the user's total account holdings with the organization. The score may be determined using a variety of calculation techniques such as, for example, percentage of total client assets placed with the organization at risk from the event, time between the current date and an expected life event (e.g., retirement, marriage, attending college, etc.), etc. For examples in which the event impact scores are calculated based upon the percentage of total client assets placed with the organization at risk from the event, the output event impact score is based upon a set of values assigned for various percentage ranges. For example, a set of impact score ranges for percentage of total assets at risk may be calculated as a score of 1 for ratios between 0 and 0.09, a score of 2 for ratios between 0.1 and 0.19, a score of 3 for ratios between 0.2 and 0.29, a score of 4 for ratios between 0.3 and 0.39, a score of 5 for ratios between 0.4 and 0.49, a score of 6 for ratios between 0.5 and 0.59, a score of 7 for ratios between 0.6 and 0.69, a score of 8 for ratios between 0.7 and 0.79, a score of 9 for ratios between 0.8 and 0.89, and a score of 10 for ratios over 0.9. It may be readily understood that a variety of score calculation techniques and method may be employed to assign the event impact score based on factors that are most relevant to the organization and the specifics of the individuals engaged in a relationship with the organization. The event impact score may be used by the interaction prediction and response engine 200 as an input used in the prediction of whether (or not) a user is likely to initiate interaction based on the event.

A user profile may be evaluated against the model to predict whether the user is likely to initiate contact. For example, features may be extracted from the user profile data and evaluated against the model generated using profile information of other users initiating interaction based on the event to determine the likelihood that the user will initiate interaction. In some examples, multiple user profile attributes may be evaluated against the model to determine individual probabilities for the attribute and/or composite probabilities for one or more sets of user profile attributes. In some examples, an interaction preference may be established for the user profile indicating whether or not the user prefers interaction with the organization. The interaction preference may be established by analyzing past interactions of the user as well as other data include in the user's profile such as for example, preference settings, contact options, etc.

Upon predicting that the user is likely to initiate contact, options may be generated by the interaction prediction and response engine 200 for responding to the event. The response options may include a variety of data such as, for example, the organization's (e.g., the business holding the user's account, etc.) approved guidance regarding the ramifications of the event, actions that the user may take to address the event, links to information the organization deems reliable for the user to consult to obtain additional information about the event, and/or any other information and/or guidance that the organization deems likely to give the user the information that may have been obtained thorough an initiated interaction. In some examples, the interaction data may be analyzed to determine the information resulting in ending one or more interactions and the information may be used in generating the response options.

The response options may be transmitted to an administrator (e.g., account manager, customer service representative, advisor, etc.) who may then choose one or more of the options for transmission to the user. The response options may be generated to be delivered through a communication channel likely to deliver the information in the timeliest manner. For example, the interaction prediction and response engine may determine that the user is currently connected to a social network and the response option may be generated to be delivered to the user via social media.

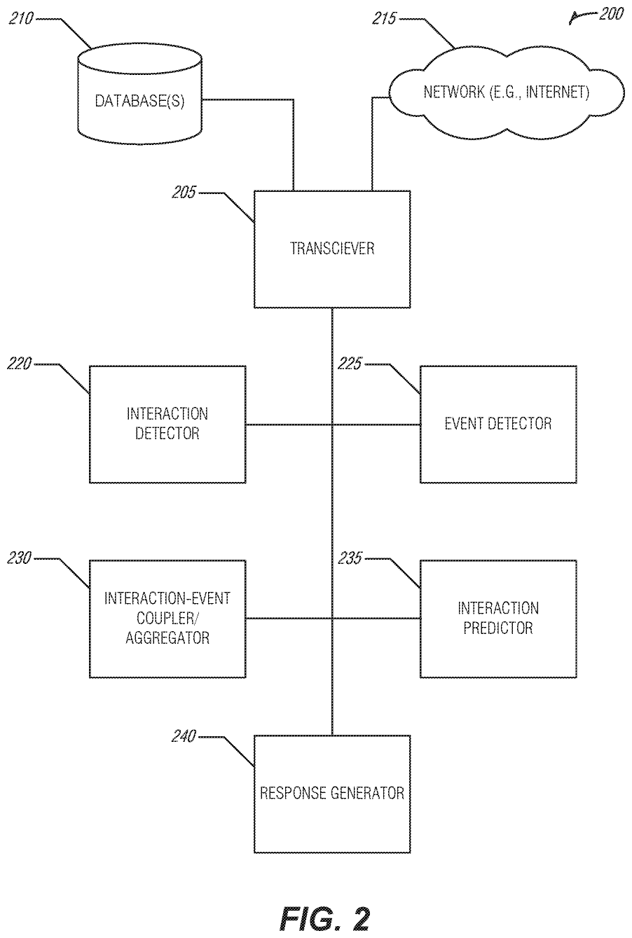

FIG. 2 illustrates a block diagram of an example of an interaction prediction and response engine 200 for response generation for predicted event-driven interactions, according to some embodiments. The interaction prediction and response engine 200 may include a transceiver 205 that is communicatively coupled to database(s) 210 and a network 215 (e.g., the internet, wired network, wireless network, etc.). The transceiver 205 may be communicatively coupled (e.g., over a network, shared bus, etc.) to an interaction detector 220, an event detector 225, an interaction-event coupler/aggregator 230, an interaction predictor 235, and a response generator 240.

The transceiver 205 may process incoming and outgoing data. For example, the transceiver may transmit a request to the database(s) 210 and/or to a data source connected to the network 215 for input data. The transceiver 205 may forward the received input data to other components of the interaction prediction and response engine 200 such as the interaction detector 220, the event detector 225, interaction-event coupler/aggregator 230, the interaction predictor 235, and the response generator.

The transceiver may receive data from components of the interaction prediction and response engine 200 for outgoing transmission to the database(s) 210 and/or the network 215. For example, a set of options generated by the response generator 240 may be transmitted to the transceiver for forwarding to a host connected to the network 215.

The database(s) 210 may include a variety of data structures storing information for use by the interaction prediction and response generator 200. The database(s) may include, by way of example and not limitation, a database containing interaction data describing interactions between individuals and an organization, a user profile database corresponding to individuals having a relationship with the organization, an interaction model database containing models representing individuals likely to initiate interaction with the organization, etc.

The data sources may include a variety of information about current events including news articles, blog posts, social media posts, etc. The interaction data may include information including a user profile of an individual making the interaction, topics discussed during the interaction, resolution of the interaction, etc. User profile data may include user profile attributes. The user attributes may include demographic information such as the user's age, occupation, education level, educational institutions attended, etc. The user attributes may include information regarding the user's relationship with the organization including pervious interactions with the organization, business concerns (e.g., asset holdings, purchase history, etc.), preferences (e.g., contact preferences, etc.), etc.

The network 215 may provide access to a variety of network connected resources. For example, the network may provide access to internet-based resources, a corporate network, a local area network, etc. The network 215 may be used to communicate with a variety of data sources. For example, the data sources may include social media sites, news websites, news feeds, corporate websites, research databases, etc. The interaction prediction and response engine 200 may request data from the data sources for use in detecting the occurrence of events.

The interaction detector 220 may obtain (e.g., using the transceiver 205) a set of interaction data (e.g., from the database(s) 210). The interaction detector 220 may analyze the interaction data to aggregate the interactions by topic discussed during the interaction. The interaction detector 220 may use a variety of data analysis techniques to determine similarities between the interactions such as, for example, keyword searching, pattern matching, etc. For example, the interaction detector 220 may aggregate interactions with discussions including the keywords ACME and bankruptcy. In some examples, the event detector may determine that there has been an increase in interactions. For example, over a one hour period 500 interactions may be a baseline metric for interactions and it may be determined that there is an increase in interactions because there were 750 interactions in the most recent one hour period.

The event detector 225 may obtain (e.g., using the transceiver 205) a set of event data (e.g., from data sources connected to the network 215). The event detector 225 may analyze the set of event data to detect an event. The event detector 225 may aggregate event data elements in the set of event data based on similarities between the event data elements. The analysis may use a variety of data analytics techniques such as, for example, keyword searching, pattern matching, etc. to determine the similarity of event data elements. For example, a news article and a social media post may be aggregated based on each containing a discussion of an ACME bankruptcy filing.

In some examples, the set of event data may be obtained in response to an increase in interactions detected by the interaction detector 220. For example, an increase in interactions may be detected that discuss the ACME bankruptcy and a set of event data may be gathered relating to the ACME bankruptcy. For example, the event detector 225 may obtain information from a variety of data sources that discuss the ACME bankruptcy. In some examples, the set of interaction data and the set of event data may be obtained in response to determining the set of event data includes event data elements above a threshold. For example, the event detector 225 may collect additional event data and may prompt the interaction detector 220 to obtain a set of interaction data based on there being more than 10 unique event data elements discussing the ACME bankruptcy.

The interaction-event coupler/aggregator 230 may evaluate the set of event data and the set of interaction data to determine a correlation between an event corresponding to the set event data and an interaction corresponding to the set of interaction data. For example, the correlation may be determined based on keyword overlap between event data elements and interaction data elements. For example, event data elements containing a discussion of the ACME bankruptcy may be coupled to the interaction data elements discussing the ACME bankruptcy. In some examples, the set of event data and the set of interaction data may contain more than one topic and the data sets may be aggregated after coupling into topic based datasets. The aggregated datasets may be forwarded to the interaction predictor for further processing.

The interaction predictor 235 may collect a set of profile data associated with the interaction. In an example, the interaction predictor 235 may determine user profiles of the individuals that initiated the interactions. For example, the John, Pete, and Carol may have interactions included in a dataset for the topic ACME bankruptcy and their profiles data (e.g., user profile attributes, etc.) may be collected and added to the set of profile data.

The interaction predictor 235 may compare the set of profile data to a user profile (e.g., user profile attributes, etc.) to determine a predicted interaction. For example, Sam's profile may be compared to the set of user profile data to predict whether Sam will initiate an interaction.

In some examples, the interaction predictor 235 may evaluate a set of user profile attributes of the user profile to an interaction preference model to determine an interaction preference for the user profile. For example, Sam's profile attributes may indicate that Sam prefers to collaborate with an advisor for account management and it may be determined that Sam's interaction preference indicates a 0.5 probability that Sam will initiate interaction for events affecting the account. The interaction predictor 235 may compare the set of user profile attributes to the set of event data to determine an event impact score for the user profile (e.g., as previously discussed in FIG. 1). For example, Sam's account at the organization may include 90% ACME company stock and the event impact score for Sam may be 10 for the event ACME bankruptcy based on the large holding. In some examples, the event impact score may correspond to a probability a user with that score prefers to initiate interaction. For example, a score of 10 may indicate a probability of 1 that the user prefers to initiate interaction and a score of 1 may indicate a probability of 0.1 that the user prefers (or doesn't prefer) to initiate interaction. In some examples, the predicted interaction may be determined using the interaction preference and the event impact score. A variety of techniques may be used to calculate the probability, and thus predict, that the user will initiate interaction. For example, the probability corresponding to the interaction preference and the event impact score may be multiplied, averaged, etc. to determine the predicted interaction. For example, Sam's interaction preference score of 0.5 may be multiplied by Sam's impact score of 0.5 resulting in a probability of 0.5 that Sam will initiate interaction. The probability may be compared to a predetermined threshold to predict the interaction. For example, composite probabilities equal to or greater than a threshold of 0.5 may result in a prediction that the user will initiate interaction.

In some examples, the interaction predictor 235 may determine a user event using the set of user profile attributes of the user profile. As discussed in FIG. 1, a variety of user events (e.g., life events, etc.) may be determined for the user. For example, Sam may have a profile attribute indicating that Sam may retire in 5 years and the user event may be determined to be retiring in 5 years. The life event may correspond to a probability that a user with the given user event will initiate interaction. For example, Sam's retirement in 5 years may correspond to an increased probability of 0.7 that Sam will initiate interaction. The predicted interaction may be determined using the user event and the event impact score. A variety of calculation techniques may be used to generate a composite probability using the probabilities corresponding to user event and the event impact score. For example, the probabilities may be multiplied, averaged, summed, etc. For example, the 0.7 probability corresponding to Sam's retirement in five years may be averaged with Sam's event impact score of 0.5 resulting in a composite probability of 0.6 that Sam will initiate an interaction. The composite probability may me compared to a predetermined threshold or evaluated using other statistical analysis techniques to predict that Sam will initiate interaction.

In some examples, the interaction predictor 235 may evaluate the set of user profile attributes of the user profile to an interaction preference model to determine an interaction score for the user. For example, the user profile data of the individuals initiating interaction may be analyzed to generate a statistical model of individuals initiating contact. The user profile attributes of the user may then be evaluated against the model using a variety of statistical analysis techniques to determine a probability that a user with the user's attributes will initiate interaction. For example, the model may contain a set of probability distributions for parameters representing profile attributes of the individuals initiating interaction and the user's profile attributes may be input as variables to determine a score representing the user's preference for initiating interaction. For example, an evaluation of Sam's user profile attributes as inputs to the interaction preference model analysis may result in an output interaction score of 8 representing a 0.8 probability that Sam will initiate interaction. The predicted interaction may be determined using the interaction score and the event impact score. For example, the model may include a features for determining the interaction score and the event impact score and evaluating the user profile against the model may output a composite probability using the output interaction score and event impact score. For example, the 0.8 probability corresponding to Sam's interaction score of 8 may be combined (e.g., multiplied, summed, averaged, etc.) with Sam's event impact score of 0.5 resulting in a 0.4 probability that Sam will initiate interaction which may result in a prediction that Sam will initiate interaction. In some examples, the interaction score and/or the event impact score may be weighted to adjust for the relative importance of the components. For example, Sam's event impact score probability of 0.5 may be weighted to represent 1.5 and combined with Sam's interaction score of 0.8 to result in a probability of 1.2.

The response generator 240 may generate response options for responding to the event detected and resulting in a predicted interaction. The response options may include a variety of information that may be transmitted to the user to prevent interaction initiation. In some examples, the response generator 240 may analyze the set of interaction data corresponding to the event to determine information leading to a resolution to the interaction. For example, the set of interaction data may include a number of sell orders for ACME stock for interactions corresponding to the ACME bankruptcy event and a response option may be generated including guidance for placing a sell order. In some examples, the response options may include interactive display elements that, upon interaction, initiate an activity to be completed by the user. For example, the response option for including guidance for a placing a sell order may include a button or a link initializing a graphical user interface used to place the sell order.

The options for responding to the predicted interaction may be transmitted (e.g., using the transceiver 205) to an administrator. In some examples, the predicted interaction may be transmitted to an alert system to notify the administrator of the predicted interaction. In an example, the alert system may include an interactive element that, upon interaction, displays options for responding to the predicted interaction. In some examples, the predicted interaction and the options for responding may be transmitted to a dashboard displayed on a computing device of the administrator. For example, the response options may be transmitted through the alert system to a display device with an indication of the user, the predicted interaction, and the options for responding to the predicted interaction. The administrator may be able to click, drag, or otherwise select a response option to transmit to the user. In some examples, the predicted interaction may be transmitted to a computing device of the administrator via a message. The message may include an interactive element that, upon interaction, display the options for responding to the predicted message. A response option selected in the message may be transmitted to the user for display on a display device.

In some examples, the response generator 240 may determine a communication channel preference for the user profile using the set of user profile attributes. For example, user profile attributes such as, for example, previous interactions, communication preferences, notes, etc. may be analyzed to determine a communication channel preference for the user profile. Communication channels may include, by way of example and not limitation, email, telephone, social media, blog post, etc. One or more of the options for responding to the predicted interaction may be generated using the communication channel preference. For example, Sam may prefer social media as a communication channel and one of the generated options may be a message to be send via a messaging feature of a social network.

In some examples, the response generator 240 may determine a current communication channel of the user. For example, Sam's user profile may include a social media presence and it may be determined that Sam is currently present on the social network. In another example, Sam may have recently initiated interaction regarding an unrelated topic via telephone and it may be determined that Sam is currently available via telephone.

The transceiver 205, database(s) 210, interaction detector 220, event detector 225, interaction-event coupler/aggregator 230, interaction predictor 235, and response generator 240 may be implemented in hardware, software, or some combination of hardware and software. The transceiver 205, database(s) 210, interaction detector 220, event detector 225, interaction-event coupler/aggregator 230, interaction predictor 235, and response generator 240 may be implemented in the same computing system (e.g., a single server, a collection of servers, a cloud-based computing platform, etc.) or may be implemented in one or more other computing systems.

Examples, used herein generally discuss a security brokerage scenario. However, it may be understood that the techniques described may be used to predict and respond to a variety of interactions between an individual and an organization.

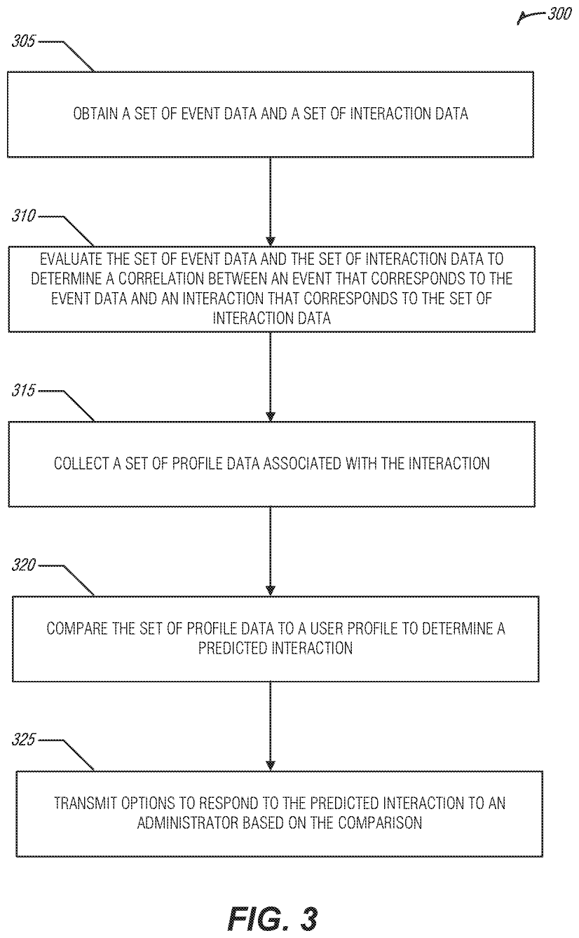

FIG. 3 illustrates flow diagram of an example of a method 300 for response generation for predicted event-driven interactions, according to some embodiments. The method 300 may perform a variety of operations of the interaction prediction and response engine 200 as described in FIGS. 1 & 2.

At operation 305, a set of event data and a set of interaction data is obtained (e.g. by the transceiver 205 as described in FIG. 2). In an example, one or more data sources may be accessed to obtain the set of event data. In an example, the set of event data and the set of interaction data may be obtained in response to determining an increase in interaction compared to a baseline interaction metric. In some examples, the set of event data and the set of interaction data may be obtained in response to determining the set of event data includes event data elements above a threshold.

At operation 310, the set of event data and the set of interaction data is evaluated (e.g., by the interaction-event coupler/aggregator 230 described in FIG. 2) to determine a correlation between an event that corresponds to the event data and an interaction that corresponds to the interaction data.

At operation 315, a set of profile data associated with the interaction is collected (e.g., by the interaction predictor 235 as described in FIG. 2).

At operation 320, the set of profile data is compared (e.g., by the interaction predictor 235 as described in FIG. 2) to a user profile to determine a predicted interaction (e.g., whether an interaction will occur, etc.). In some examples, a set of user profile attributes of the user profile may be evaluated against an interaction preference model to determine an interaction preference for the user profile. The set of user profile attributes may be compared to the set of event data to determine an event impact score for the user profile and the predicted interaction may be determined using the interaction preference and the event impact score.

In some examples, a user event (e.g., a life event, marriage, birth of a child, retirement, etc.) may be determined using a set of user profile attributes of the user profile. The set of user profile attributes may be compared to the set of event data to determine an event impact score for the user profile and the predicted interaction may be determined using the user event and the event impact score.

In some examples, a set of user profile attributes of the user profile may be evaluated against an interaction preference model to determine an interaction score for the user profile. The set of user profile attributes may be compared to the set of event data to determine an event impact score for the user profile and the predicted interaction may be determined using the interaction score and the event impact score.

At operation 325, options to respond (e.g., generated by the response generator 240 as described in FIG. 2) to the predicted interaction are transmitted (e.g., by the transceiver 205 as described in FIG. 2) to an administrator based on the comparison. In some examples, the options for responding the predicted interaction may be transmitted to an alert system to notify the administrator of the predicted interaction. The alert system may include an interactive element that, upon interaction, displays the options to respond to the predicted interaction. In some examples, the predicted interaction and the options to respond to the predicted interaction may be transmitted to a dashboard displayed on a computing device of the administrator. In some examples, the predicted interaction may be transmitted to the administrator via a message. The message may include an interactive element that, upon interaction, displays the options to respond to the predicted interaction.

In some examples, a communication channel preference may be determined (e.g., by the response generator 240 as described in FIG. 2) for the user profile using a set of user profile attributes. One or more of the options to respond to the predicted interaction may be generated (e.g., by the response generator 240 as described in FIG. 2) using the communication channel preference.

FIG. 4 illustrates an example machine learning component 400 for response generation for predicted event-driven interactions, according to some embodiments. Machine learning module utilizes a training module 405 and a prediction module 410. Training module 405 feeds user interaction data 415 and event information 420 into feature determination module 425 which determines one or more features 430 from this information. Features 430 are a subset of the information input and is information determined to be predictive of whether a user is likely to initiate interaction. Examples include one or more of: age of the user, asset holdings of the user, previous interactions with the user, life events/milestones of the user, etc.

The machine learning algorithm 435 produces an interaction model 440 based upon the features and feedback associated with those features. For example, the features associated with interactions of other users relating to the event are used as a set of training data. As noted above, the response model 440 may be for the entire system (e.g., built of training data accumulated throughout the entire system, regardless of the users initiating interaction), or may be built specific for each event, each interaction, or event and interaction pair.

In the prediction module 410, the current user profile data 445 may be input to the feature determination module 450. Similarly the event information 455 is also input to the feature determination module 450. Feature determination module 450 may determine the same set of features or a different set of features as feature determination module 425. In some examples, feature determination module 450 and 425 are the same module. Feature determination module 450 produces features 460, which are input into the interaction model 440 to generate an interaction prediction 465. The training module 405 may operate in an offline manner to train the interaction model 440. The prediction module 410, however, may be designed to operate in an online manner as each user profile is evaluated as the event occurs.

It should be noted that the interaction model 440 may be periodically updated via additional training and/or user feedback. The user feedback may be either feedback from users giving explicit feedback (e.g., responses to questions about whether the interaction was a result of the event, etc.). Also, cases in which a user initiating interaction provides an explicit response may be used as additional training data for updating the interaction model 440.

The machine learning algorithm 435 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, and hidden Markov models. Examples of unsupervised learning algorithms include expectation-maximization algorithms, vector quantization, and information bottleneck method. In an example embodiment, a multi-class logistical regression model is used.

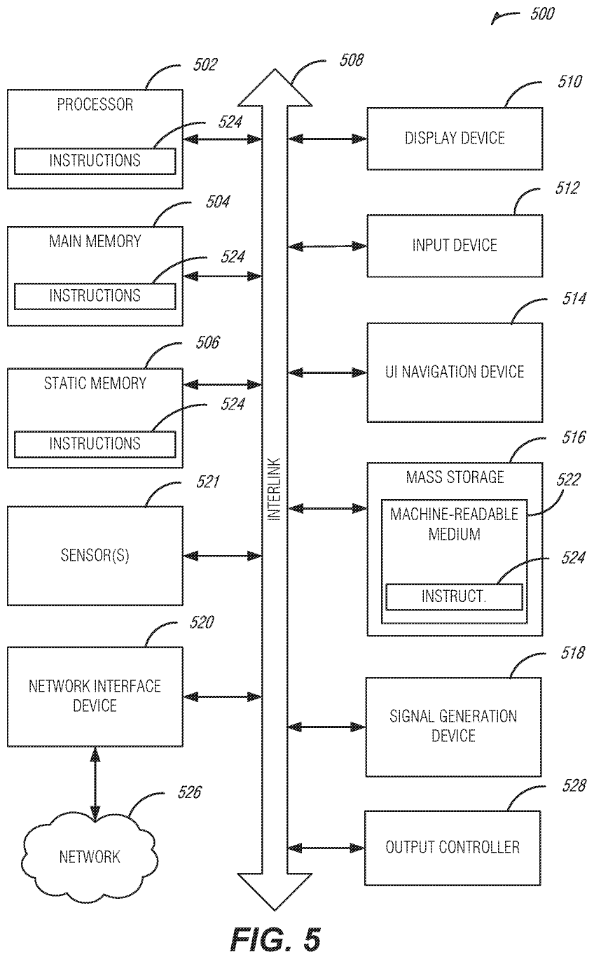

Interaction prediction and response engine 200 and machine learning module 400 may be implemented on one or more computing devices, such as machine 500 of FIG. 5. As such, some of the components of FIGS. 2 & 5 may communicate with each other via inter-process communication and other local communications techniques (e.g., shared memory, pipes, buffers, queues). In other examples, the components of FIGS. 2 & 5 may be parts of different services or systems and thus the modules may communicate with each other through a computer network using computer networking protocols.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for targeted trend response, the system comprising:
at least one processor;
a memory including instructions that, when executed by the at least one processor, cause the at least one processor to perform operations to:
obtain a set of event data and a set of interaction data, wherein the set of event data describes an event associated with a first entity, and wherein the set of interaction data describes an interaction between the first entity and a second entity;
evaluate the set of event data and the set of interaction data to determine a correlation between the event that corresponds to the set of event data and the interaction that corresponds to the set of interaction data;
collect a set of profile data associated with the interaction, wherein the set of profile data describes the second entity;
compare the set of profile data to a user profile to determine a predicted interaction, wherein the user profile describes a third entity, and wherein the predicted interaction is determined based on a similarity between members of the set of profile data and attributes included in the user profile, wherein the operations to compare the set of profile data to the user profile to determine the predicted interaction further perform operations to:
apply a set of user profile attributes of the user profile to an interaction preference model to determine an interaction preference for the user profile, the interaction preference model configured using a set of user profiles and event data to identify user attributes corresponding to interaction preferences and wherein for each user profile of the set of user profiles includes user profile attributes and interaction preferences;
compare the set of user profile attributes to the set of event data to determine an event impact score for the user profile, wherein the event impact score is determined based on a variation of a value of a member of the set of user profile attributes based on an adjustment indicated by a corresponding value for a member of the set of event data; and
determine, for the user profile, the predicted interaction for an event, using the interaction preference, event data associated with the event, and the event impact score;
transmit a graphical display of options to respond to the predicted interaction to an administrator based on the comparison;
receive an interaction indicator related to the event for the user profile, wherein the interaction indicator indicates a user initiated interaction for the event; and
update the interaction preference model using the interaction indicator.

2. The system of claim 1, the operations to obtain the set of event data and the set of interaction data further comprising operations to:
access one or more data sources that contain information about an event.

3. The system of claim 1, further comprising operations to:
determine an increase in interactions compared to a baseline interaction metric; and
obtain the set of event data and the set of interaction data in response to the determination.

4. The system of claim 1, further comprising operations to:
determine the set of event data includes event data elements above a threshold; and
obtain the set of event data and the set of interaction data in response to the determination.

5. (canceled)

6. The system of claim 1, the operations to compare the set of profile data to a user profile to determine the predicted interaction further comprising operations to:
determine a user event using a set of user profile attributes of the user profile;
compare the set of user profile attributes to the set of event data to determine an event impact score for the user profile; and
determine the predicted interaction using the user event and the event impact score.

7. The system of claim 1, the operations to transmit options to respond to the predicted interaction to the administrator further comprising operations to:
transmit the options to respond to the predicted interaction to an alert system to notify the administrator of the predicted interaction, wherein the alert system includes an interactive element that, upon interaction, displays the options to responding to the predicted interaction.

8. The system of claim 1, the operations to transmit options to respond to the predicted interaction to the administrator further comprising operations to:
transmit the predicted interaction and the options to respond to the predicted interaction to a dashboard displayed on a computing device of the administrator.

9. The system of claim 1, the operations to transmit options to respond to the predicted interaction to the administrator further comprising operation to:
transmit the predicted interaction to the administrator via a message, wherein the message includes an interactive element that, upon interaction, displays the options for responding to the predicted interaction.

10. The system of claim 1, further comprising operations to:
determine a communication channel preference for the user profile using a set of user profile attributes; and
generate one or more of the options to respond to the predicted interaction using the communication channel preference.

11. At least one non-transitory computer readable storage medium including instructions for targeted trend response that, when executed by a computer, cause the computer to perform operations to:
obtain a set of event data and a set of interaction data, wherein the set of event data describes an event associated with a first entity, and wherein the set of interaction data describes an interaction between the first entity and a second entity;
evaluate the set of event data and the set of interaction data to determine a correlation between the event that corresponds to the set of event data and the interaction that corresponds to the set of interaction data;
collect a set of profile data associated with the interaction, wherein the set of profile data describes the second entity;
compare the set of profile data to a user profile to determine a predicted interaction, wherein the user profile describes a third entity, and wherein the predicted interaction is determined based on a similarity between members of the set of profile data and attributes included in the user profile, wherein the operations to compare the set of profile data to the user profile to determine the predicted interaction further comprising operations to:
apply a set of user profile attributes of the user profile to an interaction preference model to determine an interaction preference for the user profile, the interaction preference model configured using a set of user profiles and event data to identify user attributes corresponding to interaction preferences and wherein for each user profile of the set of user profiles includes user profile attributes and interaction preferences;
compare the set of user profile attributes to the set of event data to determine an event impact score for the user profile, wherein the event impact score is determined based on a variation of a value of a member of the set of user profile attributes based on an adjustment indicated by a corresponding value for a member of the set of event data; and
determine, for the user profile, the predicted interaction for an event, using the interaction preference, event data associated with the event, and the event impact score;
transmit a graphical display of options to respond to the predicted interaction to an administrator based on the comparison;
receive an interaction indicator related to the event for the user profile, wherein the interaction indicator indicates a user initiated interaction for the event; and
update the interaction preference model using the interaction indicator.

12. The at least one non-transitory computer readable storage medium of claim 11, the operations to obtain the set of event data and the set of interaction data further comprising operations to:
access one or more data sources that contain information about an event.

13. The at least one non-transitory computer readable storage medium of claim 11, further comprising operations to:
determine an increase in interactions compared to a baseline interaction metric; and
obtain the set of event data and the set of interaction data in response to the determination.

14. The at least one non-transitory computer readable storage medium of claim 11, further comprising operations to:
determine the set of event data includes event data elements above a threshold; and
obtain the set of event data and the set of interaction data in response to the determination.

15. (canceled)

16. The at least one non-transitory computer readable storage medium of claim 11, the operations to compare the set of profile data to a user profile to determine the predicted interaction further comprising operations to:
determine a user event using a set of user profile attributes of the user profile;
compare the set of user profile attributes to the set of event data to determine an event impact score for the user profile; and
determine the predicted interaction using the user event and the event impact score.

17. The at least one non-transitory computer readable storage medium of claim 11, the operations to transmit options to respond to the predicted interaction to the administrator further comprising operations to:
transmit the options to respond to the predicted interaction to an alert at least one computer readable medium to notify the administrator of the predicted interaction, wherein the alert at least one computer readable medium includes an interactive element that, upon interaction, displays the options to responding to the predicted interaction.

18. The at least one non-transitory computer readable storage medium of claim 11, the operations to transmit options to respond to the predicted interaction to the administrator further comprising operations to:
transmit the predicted interaction and the options to respond to the predicted interaction to a dashboard displayed on a computing device of the administrator.

19. The at least one non-transitory computer readable storage medium of claim 11, the operations to transmit options to respond to the predicted interaction to the administrator further comprising operation to:
transmit the predicted interaction to the administrator via a message, wherein the message includes an interactive element that, upon interaction, displays the options for responding to the predicted interaction.

20. The at least one non-transitory computer readable storage medium of claim 11, further comprising operations to:
determine a communication channel preference for the user profile using a set of user profile attributes; and
generate one or more of the options to respond to the predicted interaction using the communication channel preference.

21. A method for targeted trend response, the method comprising:
obtaining a set of event data and a set of interaction data, wherein the set of event data describes an event associated with a first entity, and wherein the set of interaction data describes an interaction between the first entity and a second entity;
evaluating the set of event data and the set of interaction data to determine a correlation between the event corresponding to the set of event data and the interaction corresponding to the set of interaction data;
collecting a set of profile data associated with the interaction, wherein the set of profile data describes the second entity;
comparing the set of profile data to a user profile to determine a predicted interaction, wherein the user profile describes a third entity, and wherein the predicted interaction is determined based on a similarity between members of the set of profile data and attributes included in the user profile, wherein comparing the set of profile data to user profile to determine the predicted interaction further comprising:
applying a set of user profile attributes of the user profile to an interaction preference model to determine an interaction preference for the user profile the interaction preference model configured using a set of user profiles and event data to identify user attributes corresponding to interaction preferences and wherein for each user profile of the set of user profiles includes user profile attributes and interaction preferences;
comparing the set of user profile attributes to the set of event data to determine an event impact score for the user profile, wherein the event impact score is determined based on a variation of a value of a member of the set of user profile attributes based on an adjustment indicated by a corresponding value for a member of the set of event data; and
determining, for the user profile, the predicted interaction for an event, using the interaction preference, event data associated with the event, and the event impact score;
transmitting a graphical display of options for responding to the predicted interaction to an administrator based on the comparing;
receiving an interaction indicator related to the event for the user profile, wherein the interaction indicator indicates a user initiated interaction for the event; and
updating the interaction preference model using the interaction indicator.

22. The method of claim 21, wherein obtaining the set of event data comprises accessing one or more data sources containing information about an event.

23. The method of claim 21, wherein obtaining the set of event data and the set of interaction data is in response to determining an increase in interactions compared to a baseline interaction metric.

24. The method of claim 21, wherein obtaining the set of event data and the set of interaction data is in response to determining the set of event data includes event data elements above a threshold.

25. (canceled)

26. The method of claim 21, wherein comparing the set of profile data to a user profile to determine the predicted interaction further comprises:
determining a user event using a set of user profile attributes of the user profile;
comparing the set of user profile attributes to the set of event data to determine an event impact score for the user profile; and
determining the predicted interaction using the user event and the event impact score.

27. The method of claim 21, wherein transmitting options for responding to the predicted interaction to the administrator comprises transmitting the options for responding the predicted interaction to an alert system to notify the administrator of the predicted interaction, wherein the alert system includes an interactive element that, upon interaction, displays the options for responding to the predicted interaction.

28. The method of claim 21, wherein transmitting options for responding to the predicted interaction to the administrator comprises transmitting the predicted interaction and the options for responding to the predicted interaction to a dashboard displayed on a computing device of the administrator.

29. The method of claim 21, wherein transmitting options for responding to the predicted interaction to the administrator comprises transmitting the predicted interaction to the administrator via a message, wherein the message includes an interactive element that, upon interaction, displays the options for responding to the predicted interaction.

30. The method of claim 21, further comprising:
determining a communication channel preference for the user profile using a set of user profile attributes; and
generating one or more of the options for responding to the predicted interaction using the communication channel preference.
